(19) United States
(12) Patent Application Publication
(10) Pub. No.: US 2013/0272827 A1
(43) Pub. Date: Oct. 17, 2013

(54) CONTAINER TRANSPORT SYSTEM

(71) Applicant: Beat Wegmüller, Huttwil (CH)

(72) Inventor: Beat Wegmüller, Huttwil (CH)

(73) Assignee: INNOVA TRAIN AG, Bern (CH)

(21) Appl. No.: 13/825,417

(22) PCT Filed: Sep. 21, 2011
(86) PCT No.: PCT/EP2011/004719

§ 371 Date: Jun. 6, 2013

(30) Foreign Application Priority Data
Sep. 22, 2010 (CH) 1549/10

(51) Int. Cl. B60P 1/00

(52) U.S. Cl. CPC B60P 1/00
USPC 414/343; 414/539; 414/812

(57) ABSTRACT

A transshipment device for horizontal transshipment in a container transport system for the rail and/or road sector includes at least one sliding and lifting plate, which is operated hydraulically, pneumatically or electro-mechanically, and is detachably mounted on a truck, and which interacts with at least one adapter frame which is detachably installed on a container-carrying wagon. Two sliding and lifting plates are positioned on the truck to grip and hold a container from below so that it can be carried.

The invention relates to a transshipment device for horizontal transshipment in a container transport system for the rail or road sector, a method for the horizontal transshipment of a container from a truck or other vehicle to a container-carrying wagon or rail wagon and/or to some other site, or vice versa, as well as preferred uses of the transshipment device and the container transport system itself.

Due to the fact that the containerized transport of goods of all kinds on the roads is increasing more and more in Switzerland and generally all over Europe, and the roads are often overburdened in this way, and their maintenance is becoming increasingly expensive because of the wear and tear caused by the truck shipments, there are efforts underway to restrict the long-haul road traffic not only in Switzerland but throughout Europe. This development has led to a general rethink, with an effort to make the container shipments by rail more efficient economically. However, it is not possible logistically to achieve the flexibility of truck transport, so it is often necessary to transfer containers from rail to truck to be able to quickly reach the remote destinations, as well. Therefore endeavours are being made to design this transfer from rail to truck and vice versa in a faster and more efficient way, so as to facilitate this combination of the modes of transport rail and truck and indeed make it at all feasible.

To achieve this, a system has already been developed which has become known as the ACTS system. The acronym ACTS stands for “Abroll [Roll-off] Container Transport System”. In this ACTS system the wagons, i.e. the rail wagons of the transporting railway, have a separate rotating frame. The transfer of the load, that is the transhipment, is then done by means of swivel-mounted guide rails on the wagon. And the trucks to be used for container transport are fitted with a special matching hook or chain system, called a roll-off unit. When, for example, a container is to be loaded from a wagon onto a truck, the rotating frame is turned out to an angle of about 37 to 45°, the truck drives up obliquely to the wagon, which means that a space of about 12 m at the side is needed for the manoeuvre. The container is then moved over from the wagon onto the truck using the hook or chain system fitted on the truck. The trucks that are suitable for the transport of containers using the ACTS system are also known as swap-body vehicles. In another type of design, they can also be fitted with a hydraulic lifting arm, besides the already mentioned hook or chain system.

If a container is to be moved from the truck onto the wagon, the aforesaid procedure is done in the reverse direction.

Known uses of this container transport system built according to the ACTS system are found in the field of waste and construction waste collection containers. In the field of waste collection containers, one can specifically mention used glass and used paper. Their use for industrial waste is also known.

This ACTS system has been further developed and improved to form another known horizontal transshipment system, known among specialists as Mobiler. This is a hydraulic system mounted on a heavy goods vehicle that allows the container to be transferred without a turning platform. To transfer the container or swap body, the lorry that holds, or is to receive, the container drives up to the rail wagon and parks alongside it, parallel to it. This only needs a driveway of max. 4 m width. An important feature of this transshipment system is that the container or swap body is fitted with at least one sliding channel, that fits a transfer device mounted on the truck, so that the container can be transshipped by pushing it across on parallel mountings.

Therefore to implement this system the requirement is that the rail wagon, i.e. the container-carrying wagon, has to be fitted with sliding panels welded onto it, which are also known as Mobiler panels, and that generally there are two sliding channels, the so-called Mobiler channels, welded to the underside of the container or other swap body.

The disadvantage of this known Mobiler container transshipment system is that it requires swap bodies specially made for this purpose with a built-in sliding channel. In addition to this, for this type of horizontal transshipment system the container-carrying wagons that are used each have to be subsequently fitted with additional welded-on sliding panels.

Starting from this prior art, the present invention had the basic aim of further improving the horizontal transshipment for a container transport system from rail to truck, and in particular to design it in a more flexible way and allow the use of standard swap bodies.

This task was solved by a transshipment device for horizontal transshipment in a container transport system for the rail and/or road sector, with at least one sliding and lifting plate, which is operated hydraulically, pneumatically or electro-mechanically, and is detachably mounted on a truck or vehicle, and which interacts with at least one adapter frame which is detachably installed on a container-carrying wagon or rail wagon, and/or is located at a site to or from where a container or other swap body is intended to be transferred.

Such a transfer of the container or other swap body is referred to as transshipment.

Because the container-carrying wagon or rail wagon has at least one detachably mounted adapter frame, the inventive transshipment device can be designed and used in a much more flexible way than can be done in the case of the known Mobiler transshipment system, which is also a horizontal system. Here it is no longer necessary to weld a sliding panel onto the container-carrying wagon.

What is more, the use of at least one sliding and lifting plate means an entirely new concept is being pursued. The sliding and lifting plate(s), as well as any associated support mechanisms, which will be described in more detail below, can be mounted on any standard truck. The truck equipped in this way can also be used as trailer-yard vehicle for the transfer of swap bodies, e.g. during operation in a terminal. Further, the truck can also be used as a distribution vehicle with hoisting platform.

According to a preferred embodiment of the inventive transshipment device, two sliding and lifting plates are provided, which are positioned on the truck or vehicle in such a way that they grip and hold a container or swap body from below so that it can be carried. In this case the sliding and lifting plates form bridging bars which raise the container or other swap body to the required height and then move them transversely.

Preferably the at least one sliding and lifting plate is operated by means of at least one hydraulically operated cylinder, preferably by several such cylinders, or by a pneumatic actuator using air bellows. In this way an optimum transmission of force is achieved.

The invention can be designed so that at least one sensor controls the positioning of the truck or other vehicle relative to the container-carrying wagon or rail wagon. Preferably several such positioning sensors are used, that allow an optimum positioning of the truck or other vehicle for transshipping the container or swap body.

The invention also relates to a method for the horizontal transshipment of a container from a truck or other vehicle to a container-carrying wagon or rail wagon and/or to some other site, or vice versa, in which at least one sliding and lifting plate that is detachably mounted on the truck or vehicle is operated hydraulically, pneumatically or electro-mechanically, and interacts with at least one adapter frame, which is located on the container-carrying wagon or rail wagon; where the at least one sliding and lifting plate is adjusted and levelled at a height that allows it to be pushed and inserted into the at least one adapter frame; where the at least one sliding and lifting plate is first moved transversely to dock onto the at least one adapter frame, and is then pushed and inserted into the adapter frame, thereby sliding a container or other swap body from a truck or other vehicle onto the container-carrying wagon or rail wagon and/or to some other site, or vice versa,

In this way, in particular a transshipment of the container or swap body is possible without lowering the air suspension of the truck or other vehicle. Here this suspension is provided in the usual way by air bellows. The pressure in the springs only has to be regulated enough to ensure that the wagon stays at a constant height whatever the load on the truck or other vehicle. The picking up and setting down of the container or swap body is done without actuating this air suspension

Preferably there are two sliding and lifting plates provided, which reach under the container or swap body and hold it so it can be moved. The container or swap body is then moved over by the sliding and lifting plates from the vehicle and/or other site onto the container-carrying wagon or rail wagon, or vice versa.

The invention also relates to the use of the inventive transshipment device together with the truck or vehicle, as described in detail above, to transfer containers or other swap bodies from the truck or vehicle onto a container-carrying wagon or rail wagon or vice versa.

Thus the inventive transshipment device working in conjunction with the truck or other vehicle presents an efficient concept for intermodal rail transport, by means of which the flexible transshipment of containers or other swap bodies from a container-carrying wagon or rail wagon onto a truck or other vehicle and vice versa is possible without requiring a lot of space and without much effort, quickly, and without the use of additional workers besides the driver of the truck or other vehicle. The transshipment can be done at any roadside loading track or siding. No complex infrastructure is required, as one only needs a driveway of approximately 4 m width for the truck or other vehicle. Therefore when using this flexible method of transshipment, far less costs are incurred than for permanently installed terminal equipment. The costs incurred are also less than for the known Mobiler container transshipment system, because the transshipment device does not use any welded-on parts, it only uses detachably mounted parts. The container-carrying wagons or trucks can therefore be converted or dismantled at any time.

The invention also relates to the use of the inventive transshipment device in conjunction with a truck or vehicle, as described in detail above, as a trailer-yard vehicle for the transfer of containers or other swap bodies.

This allows a full range of possible uses of the transshipment device, which yet further increases the cost-effectiveness of this intermodal loading system.

Therefore with the further inventive use of the transshipment device in conjunction with a truck or vehicle as a distribution vehicle with hoisting platform, as described in detail above, there is possible not only a design for transshipment, but a comprehensive design for the transport of containers and other swap bodies by rail to remote locations and from there by truck or vehicle to the final destination. To transfer the container at the location, or to do any lifting and moving of the container, no additional operating device is required.

Thus the invention also relates to an intermodal container transport system covering many applications, which includes a transshipment device for a horizontal transshipment as described in detail above. Here this container transport system can be used to exchange containers or other swap bodies from the truck or vehicle onto a container-carrying wagon or a rail wagon or vice versa, or as a trailer-yard vehicle for transferring containers or other swap bodies, or also as a distribution vehicle with hoisting platform, as already described above.

In what follows the invention will now be explained in more detail using example embodiments in conjunction with the attached drawing.

It is shown in:

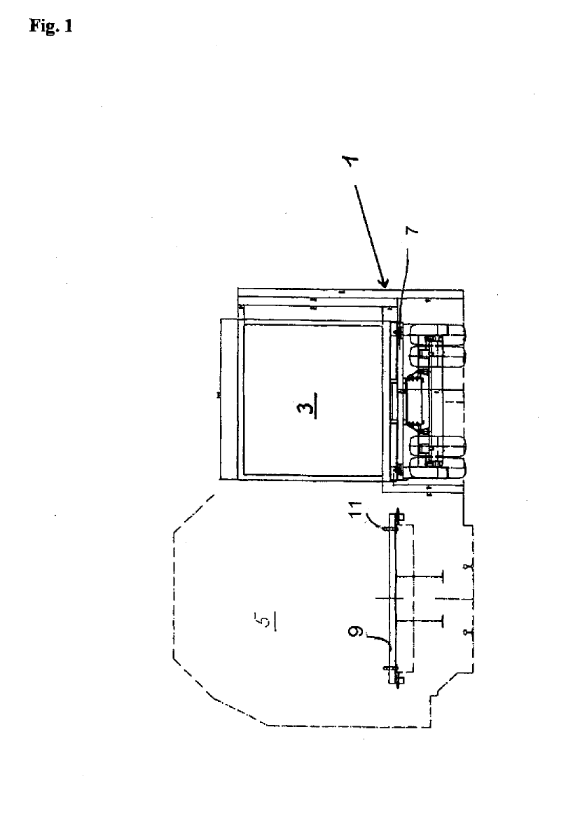

FIG. 1 a sectional view of a truck with the transshipment device and its position next to a partially depicted container-carrying wagon, showing the adapter frame.

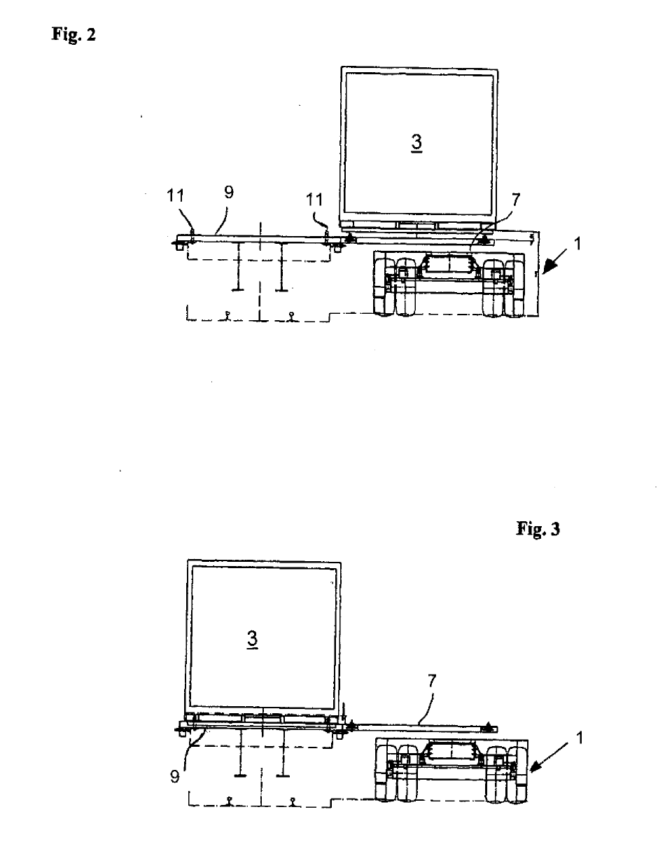

FIG. 2 a sectional view of the truck with the transshipment device next to the partially depicted container-carrying wagon, with sliding and lifting plate coupled to the adapter frame,

FIG. 3 a sectional view of the truck with the transshipment device next to the partially depicted container-carrying wagon, with sliding and lifting plate coupled to the adapter frame, and a swap body placed on it,

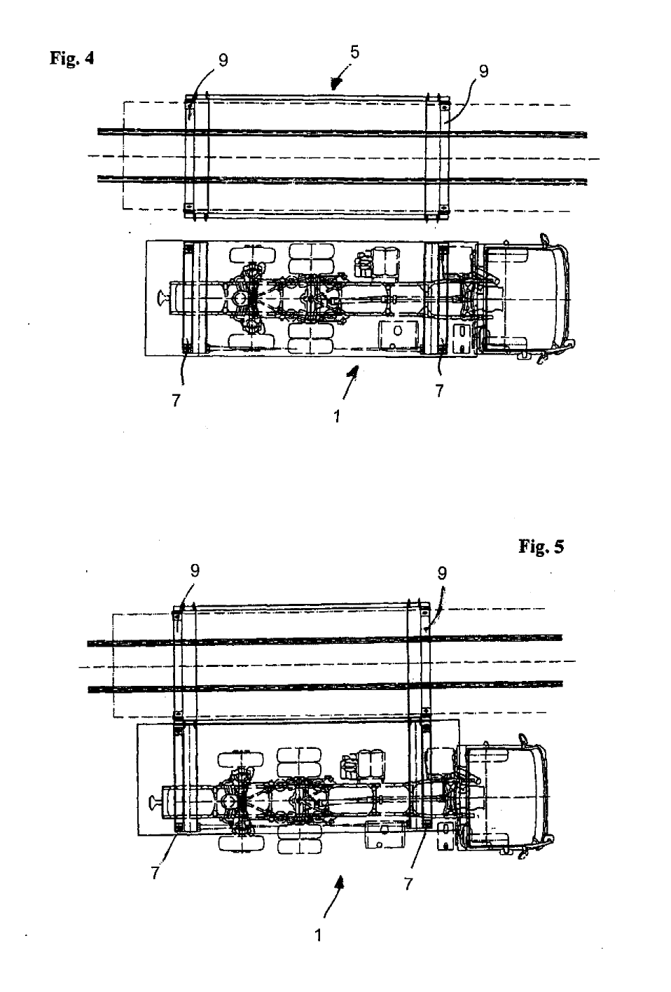

FIG. 4 a sectional view of the lower structure of the truck with the container-carrying wagon parked alongside parallel to it, in accordance with FIG. 1,

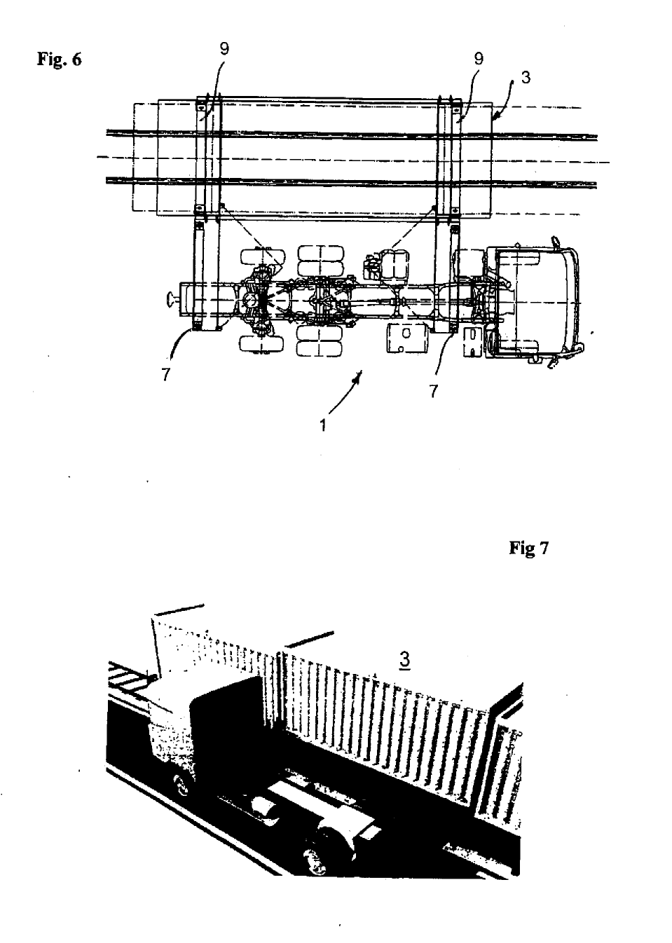

FIG. 5 a sectional view of the lower structure of the truck with the container-carrying wagon parked alongside parallel to it, in accordance with FIG. 2,

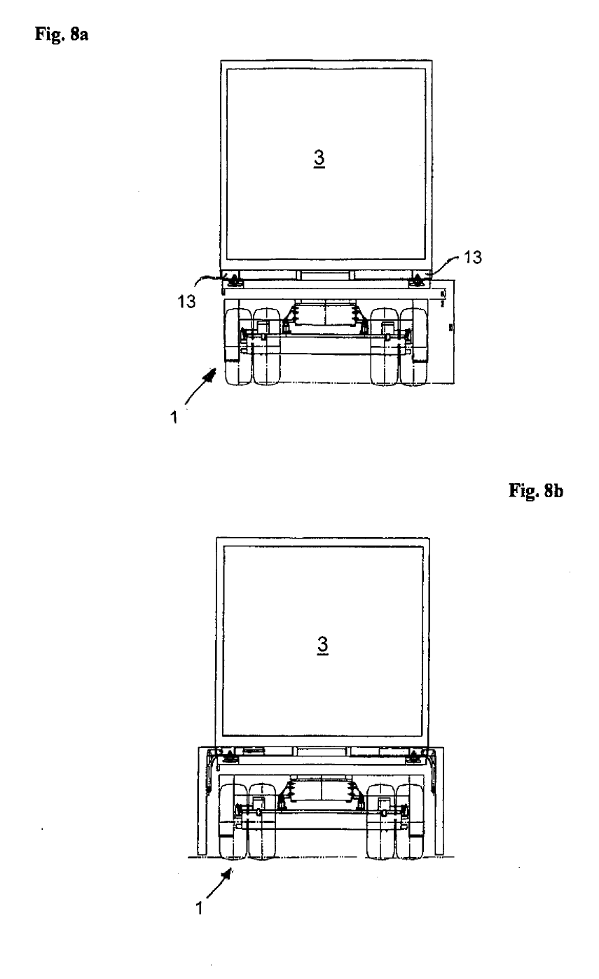

FIG. 6 a sectional view of the lower structure of the truck with the container-carrying wagon parked alongside parallel to it, in accordance with FIG. 3,

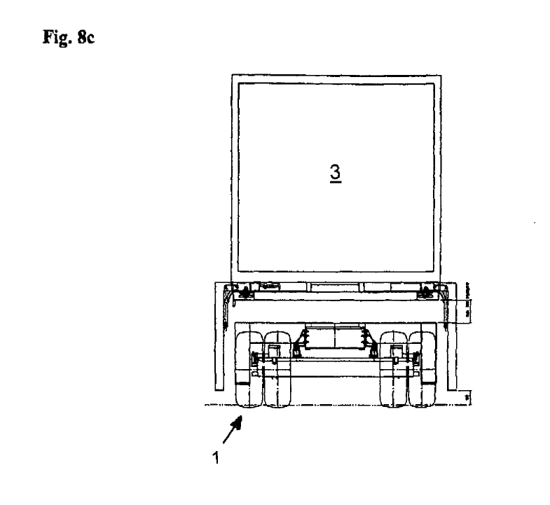

FIG. 7 a schematic view of a truck parked alongside parallel to a container-carrying wagon, with the sliding and lifting plates clearly visible, in the process of receiving a container,

FIG. 8a a sectional view of a truck with the transshipment device in use as a trailer-yard vehicle, and the container in the raised position,

FIG. 8b a sectional view according to FIG. 8a with the container lowered down, and

FIG. 8c. a sectional view according to FIGS. 8a and 8b, with the container in the raised position for transshipment.

In FIG. 1 a sectional view of a truck 1 is shown as an example of a vehicle according to the invention, which has a container 3. A standard container is used as such a container 3, of the type that is defined in standards and is generally used in logistics in accordance with the EN 12406 standard. The container has a regular capacity of 25 or 32 t. The use of the inventive transshipment device, as described in detail below, is not however limited to such standard container vessels, but can be used in general for any desired container, such as those transported on a truck.

Of fundamental importance for transferring the container 3 from the truck 1 onto a container-carrying wagon 5 that is only partially indicated in FIG. 1, are two sliding and lifting plates 7 positioned on the truck 1. These sliding and lifting plates 7 are each positioned so as to lie transverse to the longitudinal axis of the truck 1, at the end sections of the container 3, reaching underneath the container, and so are able to lift and move the container. Here the container 3 is pushed over transversely to the longitudinal axis of the truck 1. In this example embodiment, the sliding and lifting plates 7 are moved by means of hydraulic cylinders located at either side of the truck.

For the container 3 to be moved over from the truck 1 onto the container-carrying wagon 5, the truck is placed parallel to the container-carrying wagon 5, or the train to which the respective container-carrying wagon 5 belongs. Here the truck 1 is brought to stand at precisely the right position so that the place on the container-carrying wagon 5 where the container 3 is to be moved to, is located parallel to and at the height of the container 3 that is still positioned on the truck 1. The distance from the truck 1 to the container-carrying wagon 5 here is at least 600 mm. The optimum positioning of the truck 1 for the loading of the particular container is achieved by using position sensors. Suitable position sensors of this type are known and available commercially, so it is not necessary to go into this again in detail here.

The container 3 does not have to be fitted out in a special way to enable a transfer of the container 3 from the truck 1 onto the container-carrying wagon 5. In particular, it does not need to have any sliding channels permanently fixed to the bottom of the container. The movement is achieved solely by the sliding and lifting plates 7.

When the container 3 is moved from the truck 1 onto the rail wagon 5, the two are first docked onto the container-carrying wagon 5 by means of the sliding and lifting plates 7 that are moved by the pressure cylinder at the side, that is to say they are docked onto the adapter frame 9 that is provided there, as shown in FIG. 2, so that the container 3 can then be conveyed further onto the container-carrying wagon 5 by means of the adapter frame 9. For this, the container 3 is first lifted off its twistlocks, i.e. the locking devices fitted on the ISO container 3 or swap body for connecting it to the truck 1 or carrying vehicle—previously referred to as vehicle in the general sense. The form-fitting connection of the container 3 to the truck 1 using the twistlocks is familiar to the specialist, so it is not necessary to explain this further here.

Then the container 3 is pushed over onto on the container-carrying wagon 5 as shown in detail in FIG. 3. To do this the sliding and lifting plates 7 are inserted into the adapter frame(s) 9 located on the container-carrying wagon 5. In this way the sliding and lifting plates 7 engage with the adapter frame(s) 9.

Here the adapter frame 9 does not have to be permanently mounted on the container-carrying wagon 5, for example by welding it on. The adapter frame 9 is detachably mounted on a container-carrying wagon 5 operated as usual. This means that the adapter frame(s) 9 can be removed again from the container-carrying wagon 5 at any time as required, and used elsewhere, for example installed on another container-carrying wagon 5. The adapter frames 9 thus constitute a lasting investment for a logistics company.

Similar considerations apply to the sliding and lifting plates 7, which are mounted on the truck 1. Here, too, the sliding and lifting plates 7 do not have to be welded onto the truck 1 or other vehicle for their proper use. The sliding and lifting plates 7 are bolted onto the platform serving as a base to hold the container 3.

To allow the sliding and lifting plates 7 to be inserted into the adapter frame(s) 9, the level of the sliding and lifting plates 7 is adjusted to match the height of the adapter frame 9 by means of the vertical hydraulic cylinder, which has already been mentioned above, and aligned by docking with the adapter frame 9. In this way a seamless joining surface is formed between the truck 1 and the container-carrying wagon 5, for moving across the sliding and lifting plates 7.

The container 3 is then deposited on the container-carrying wagon 5 by lowering it down onto the pins 11 of the adapter frame 9, which are clearly shown in the example in FIG. 2. In this way the container 3 is firmly anchored on the adapter frame 9.

FIG. 4 once again shows, in top view, the substructure of the truck 1 with the container-carrying wagon 5 placed parallel to it, and in particular the adapter frame 9 that is there on the container-carrying wagon 5.

FIG. 5 shows, in the same plan view, the docking of the sliding and lifting plates 7 to the adapter frame 9, and in FIG. 6 the moving of the container 3 from the truck 1 across onto the container-carrying wagon 5.

FIG. 7 shows another schematic view of a truck 1 parked alongside the container-carrying wagon 5, with the sliding and lifting plates 7 clearly visible, and which is in the process of receiving the container 3 that is still located on the container-carrying wagon 5. For this, the sliding and lifting plates 7 that are docked onto the container-carrying wagon 5, reach into the adapter frame 9 that is not visible in FIG. 7. The transport of the container 3 is now done in the opposite direction to that described above, from the container-carrying wagon 5 onto the truck 1, but it can be readily seen that the same principle applies for this transport as for that from truck 1 to container-carrying wagon 5.

In FIGS. 8a to 8c one more application of the inventive transshipment device is shown, which will now be explained in detail. This is the use of the transshipment device for the stowing and transfer of containers, that is to say the use of truck 1 fitted with the sliding and lifting plates 7 as a trailer-yard vehicle.

For this, FIG. 8a shows the truck 1 with the container 3. One can see from FIG. 8a that the container 3 is in a raised position.

In FIG. 8b the container is shown in a position where it is ready for lowering down, or in the process of being lowered down. Because the container 3 is fitted with support legs 13 according to the ISO standard, it can be put down on them.

FIG. 8c is intended to illustrate the process of transferring the container 3 after it has been put down, by showing it in a raised position ready for transferring onto the truck 1.

As a precaution, in relation to the present invention it should be pointed out that in the context of container transshipment the term transshipment device is known to the specialist as an established concept in this field, but in the context of the present invention this choice of term has nonetheless been dispensed with as far as possible in order to provide a clearer definition of the invention. On principle, however, one could designate the use of the sliding and lifting plates 7 with the associated hydraulic system and the associated support mechanisms, such as, among others, the container supporting legs 13, as a transshipment device within the context of transshipment technology in the field of container transshipment.

What is claimed is:

1.-11. (canceled)

12. A transshipment device for horizontal transshipment in a container transport system for the rail and/or road sector, said transshipment device comprising:
at least one adapter frame detachably installed on a container-carrying wagon or located at a site for to or from transfer of a container or other swap body;
at least one sliding and lifting plate detachably mounted on a truck or vehicle and interacting with the at least one adapter frame; and
a drive for operating the at least one sliding and lifting plate.

13. The transshipment device of claim 12, wherein the drive is a hydraulic drive, pneumatic drive or electro-mechanical drive.

14. The transshipment device of claim 12, further comprising two of said sliding and lifting plate positioned on the truck or vehicle to grip and hold the container or swap body from below so that it can be carried.

15. The transshipment device of claim 12, wherein the drive is a hydraulic drive including at least one hydraulically operated cylinder acting on the sliding and lifting plate.

16. The transshipment device of claim 12, wherein the drive is a pneumatic drive including a pneumatic actuator using air bellows to act on the sliding and lifting plate.

17. The transshipment device of claim 12, further comprising at least one sensor configured for positioning the truck or vehicle in relation to the container-carrying wagon or rail wagon.

18. A method for horizontal transshipment of a container between a vehicle and another site, comprising:
detachably mounting at least one sliding and lifting plate on the vehicle;
positioning the at least one sliding and lifting plate at a height for interaction with at least one adapter frame positioned at the other site;
docking the at least one sliding and lifting plate onto the at least one adapter frame by moving the at least one sliding and lifting plate transversely in a direction of the at least one adapter frame; and
inserting the at least one sliding and lifting plate into the adapter frame to allow transfer of the container.

19. The method of claim 18, wherein the at least one sliding and lifting plate is operated hydraulically, pneumatically or electro-mechanically for movement in relation to the at least one adapter frame.

20. The method of claim 18, wherein two of said sliding and lifting plates are provided to grip the container from below and hold it so as to be portable.

21. In combination:
a transshipment device for horizontal transshipment in a container transport system for the rail and/or road sector, said transshipment device comprising at least one adapter frame detachably installed on a container-carrying wagon or located at a site for to or from transfer of a container or other swap body, at least one sliding and lifting plate detachably mounted on a truck or vehicle and interacting with the at least one adapter frame, and a drive for operating the at least one sliding and lifting plate; and
a truck or vehicle to move containers or other swap bodies from the truck or vehicle onto a container-carrying wagon or rail wagon, or vice versa.

22. The combination of claim 21, wherein the truck or vehicle is a trailer-yard vehicle.

23. The combination of claim 21, wherein the truck or vehicle is a distribution vehicle with hoisting platform.

24. The combination of claim 22, wherein the drive is a hydraulic drive, pneumatic drive or electro-mechanical drive.

25. The combination of claim 22, wherein the transshipment device has two of said sliding and lifting plate positioned on the truck or vehicle to grip and hold the container or swap body from below so that it can be carried.

26. The combination of claim 22, wherein the drive is a hydraulic drive including at least one hydraulically operated cylinder acting on the sliding and lifting plate.

27. The combination of claim 22, wherein the drive is a pneumatic drive including a pneumatic actuator using air bellows to act on the sliding and lifting plate.

28. The combination of claim 22, wherein the transshipment device has at least one sensor for positioning the truck or vehicle in relation to the container-carrying wagon or rail wagon.

29. An intermodal container transport system, comprising a transshipment device for horizontal transshipment, said transshipment device comprising at least one adapter frame detachably installed on a container-carrying wagon or located at a site for to or from transfer of a container or other swap body, at least one sliding and lifting plate detachably mounted on a truck or vehicle and interacting with the at least one adapter frame, and a drive for operating the at least one sliding and lifting plate.
